(19) United States
(12) Patent Application Publication
(10) Pub. No.: US 2026/0165908 A1
(43) Pub. Date: Jun. 18, 2026

(54) HEALTH CARE MASSAGE DEVICE AND OPERATION METHOD THEREOF

(71) Applicant: Yidong FU, BEIJING (CN)

(72) Inventor: Yidong FU, BEIJING (CN)

(21) Appl. No.: 18/710,467

(22) PCT Filed: Jan. 17, 2022
(86) PCT No.: PCT/CN2022/072356

§ 371 Date: May 15, 2024

(51) Int. Cl. A61H 19/00; A61H 21/00

(52) U.S. Cl. CPC A61H 19/32; A61H 21/00; A61H 2201/0192; A61H 2201/1207; A61H 2201/14; A61H 2201/1436; A61H 2201/1669; A61H 2201/1676

(57) ABSTRACT

A health care massage device and an operation method thereof are provided. The health care massage device includes: a main support (10); a reciprocating mechanism (20) including a fixed portion (21) fixedly connected to the main support (10) and a moving portion (22) reciprocating linearly relative to the fixed portion (21) ; a massager assembly (30) having a carrying support (31), and an anus massage member (32) and a penis massage member (33) which are both mounted on the carrying support (31); and a swing mechanism (40) connected to the penis massage member (33) and capable of swinging relative to the main support (10), wherein the carrying support (31) is mounted on the moving portion (22) and moves along with a movement of the moving portion (22) so as to drive the anus massage member (32) and the penis massage member (33) to reciprocate, and the penis massage member (33) is configured to swing relative to the carrying support (31) under driving of the swing mechanism (40). A user is more comfortable and less prone to fatigue during a massage process.

### TECHNICAL FIELD

The present invention relates to the field of health care instruments, in particular to a health care massage device and an operation method thereof.

### BACKGROUND

A number of nerve fibers that can stimulate the excitement and pleasure of human body are gathered in and around primary male sexual organs, and these nerve fibers may be intensely stimulated by masturbation or sexual intercourse with a spouse, so that sexual pleasure and orgasm are obtained. By massaging these human body areas abundant with sexual nerves, it is possible to realize health care or adjuvant treatment of male sexual function.

At present, there are already some health care massage instruments for male in the market. The massage operations of some health care massage devices depends on the active movements of human body, and arm or leg movements of a user are required to realize the massage of a massaged area by a massage device, so that a user is prone to fatigue and discomfort after a long use. For some health care massage devices, a user is required to maintain a standing or seating posture, so that there is also the problem that a user is prone to fatigue after a long use.

### SUMMARY

In view of this, the embodiment of the present disclosure provides a health care massage device and an operation method thereof, which can ensure that a user is more comfortable and less prone to fatigue during a massaging process.

According to one aspect of the present disclosure, a health care massage device is provided. The device includes: a main support ; a reciprocating mechanism including a fixed portion fixedly connected to the main support and a moving portion reciprocating linearly along a first direction and a direction opposite to the first direction relative to the fixed portion; a massager assembly having a carrying support, and an anus massage member and a penis massage member which are both mounted on the carrying support; and a swing mechanism connected with the penis massage member and capable of swinging relative to the main support, wherein the carrying support is mounted on the moving portion and moves along with a movement of the moving portion so as to drive the anus massage member and the penis massage member to reciprocate, and the penis massage member is configured to swing relative to the carrying support under driving of the swing mechanism.

In some embodiments, the swing mechanism is hinged with the moving portion so as to drive the moving portion to reciprocate relative to the fixed portion by a swinging of the swing mechanism.

In some embodiments, the swing mechanism includes: a torque output element fixedly connected to the main support, having a power output shaft and configured to output a torque; a crank, one end of which is fixedly connected to the power output shaft so as to rotate around an axis of the power output shaft under driving of the power output shaft; a rocker arm, one end of which is hinged with the moving portion, and the other end of which is hinged with one end of the crank away from the power output shaft so as to swing under driving of the crank and drive the moving portion to reciprocate relative to the fixed portion; and a connecting rod fixedly connected to the rocker arm and connected with the penis massage member so as to drive the penis massage member to swing relative to the carrying support along with swing of the rocker arm.

In some embodiments, the penis massage member includes: a penis massage arm swingably arranged on the carrying support; and a penis massage head arranged on the penis massage arm and configured to massage a penis, wherein the connecting rod is connected with the penis massage arm or the penis massage head through a flexible string or a rigid rod, so as to drive the penis massage head and the penis massage arm to swing through a traction of the flexible string or the rigid rod.

In some embodiments, a material of the penis massage arm is an elastic material.

In some embodiments, a length of the flexible string or the rigid rod is adjustable.

In some embodiments, the penis massage head includes: a C-shaped mounting frame arranged on the penis massage arm in an adjustable position; and a soft rubber sleeve having a massage cavity for accommodating a penis, wherein the soft rubber sleeve is detachably provided in the C-shaped mounting frame.

In some embodiments, the anus massage member includes: an anus massage arm, one end of which is hinged on the carrying support; an anus massage head arranged on the anus massage arm; and a torsion spring connected between the anus massage arm and the carrying support, and configured to apply an elastic force to the anus massage arm to cause the anus massage head to go away from the carrying support.

In some embodiments, the fixed portion includes a guide hole, and the moving portion includes: a moving member having at least one support arm connected with the carrying support; and a sliding shaft fixedly connected to or integrally formed with the moving member, wherein the sliding shaft passes through the guide hole and is slidably mated with the guide hole in the first direction.

In some embodiments, the at least one support arm includes: a first support arm, a free end of which is connected with an end of the carrying support; and a second support arm, a free end of which is provided with a support sleeve rotatable relative to the second support arm, wherein the support sleeve is configured to be sheathed on the carrying support.

In some embodiments, the health care massage device further includes: a base structure; an angle adjustment mechanism arranged between the base structure and the main support, and configured to adjust a pitch angle of the main support relative to the base structure; and a height adjustment mechanism arranged between the base structure and the main support, and configured to adjust a height of the main support relative to the base structure.

In some embodiments, the angle adjustment mechanism includes: an L-shaped bent arm, one end of which is hinged with the base structure; a linear slide rail fixedly connected to the other end of the L-shaped bent arm; and a first locking member arranged between the L-shaped bent arm and the base structure, and configured to lock or unlock a relative angle between the L-shaped bent arm and the base structure.

In some embodiments, the height adjustment mechanism includes: a slide block sleeved on the linear slide rail and slidably mated with the linear slide rail in the first direction; and a second locking member arranged between the slide block and the linear slide rail and configured to lock or unlock a relative position between the slide block and the linear slide rail, wherein the main support is fixedly connected to the slide block.

In some embodiments, the base structure includes: a bottom plate; and a plurality of support legs hinged with the bottom plate, having an adjustable deployment angle relative to the bottom plate, and configured to support the bottom plate.

In some embodiments, the plurality of support legs are configured to swing within the same swing plane, and the plurality of support legs include: two first support legs, free ends of which are both provided with a stabilizing plate, wherein a width of the stabilizing plate is greater than that of the first support legs; and two second support legs located on an opposite side of the two first support legs, wherein lengths of the two second support legs are both less than those of the two first support legs.

In some embodiments, the health care massage device further includes: a protective shell sleeved outside the main support, wherein the reciprocating mechanism and the swing mechanism are both partially arranged inside the protective shell, and the massager assembly is arranged outside the protective shell.

In some embodiments, the torque output element includes: a power adapter, an electric motor and a transmission, wherein the electric motor is electrically connected with the power adapter and connected with an input end of the transmission, an output end of the transmission is fixedly connected to the crank as the power output shaft, and the output voltage of the power adapter is adjustable.

In some embodiments, the health care massage device further includes: a protective shell sleeved outside the main support, wherein the protective shell is connected with the anus massage arm or the anus massage head through a flexible string or a rigid rod, so as to drive the anus massage head and the anus massage arm to swing relative to the carrying support during a movement process of the carrying support under a traction of the flexible string or the rigid rod.

According to one aspect of the present disclosure, an operation method for a health care massage device described previously is provided. The method includes: placing the main support between both legs of a user; causing the anus massage member in contact with an anal area of the user and causing the penis massage member in contact with a penis of the user; and operating the reciprocating mechanism to drive the anus massage member and penis massage member to reciprocate relative to the main support, and operating the swing mechanism to drive the penis massage member to swing relative to the carrying support.

In some embodiments, the operation method further includes: driving the anus massage head and the anus massage arm of the anus massage member to swing relative to the carrying support during a movement process of the carrying support under a traction of a flexible string or a rigid rod.

Therefore, according to the embodiment of the present disclosure, the main support is provided with a reciprocating mechanism and a swing mechanism to drive the massager assembly, so that the anus massage member and the penis massage member in the massager assembly may simultaneously realize the sliding massage effect on the anus and penis of the user without manually driving the massager assembly by the user or depending on the initiative movements of human body. Therefore, the user is less prone to fatigue and more comfortable during a long massage.

### BRIEF DESCRIPTION OF THE ACCOMPANYING DRAWINGS

The accompanying drawings which constitute a part of this specification, describe the embodiments of the present disclosure, and together with this specification, serve to explain the principles of the present disclosure.

The present disclosure may be more explicitly understood from the following detailed description with reference to the accompanying drawings, in which:

FIG. 1 is a schematic structural view of a health care massage device according to some embodiments c the present disclosure, in which the massager assembly and the protective shell are removed;

FIG. 2 is a schematic structural view of a health care massage device according to some embodiments of the present disclosure, in which the massager assembly is removed and the protective shell is retained;

FIG. 3 is a schematic view of a mounting structure with a protective shell in a health care massage device according to some embodiments of the present disclosure;

FIG. 4 is a schematic structural view of FIG. 3 viewed in the direction A;

FIG. 5 is a schematic structural view of the BB section in FIG. 4;

FIG. 6 is a schematic structural view of a massager assembly in a health care massage device according to some embodiments of the present disclosure;

FIG. 7 is a schematic view of a mounting structure with a protective shell in a health care massage device according to other embodiments of the present disclosure;

FIG. 8 is a flow chart of an operation method for a health care massage device according to some embodiments of the present disclosure.

It should be understood that the dimensions of various parts shown in the accompanying drawings are not drawn according to actual proportional relations. In addition, the same or similar components are denoted by the same or similar reference signs.

### DETAILED DESCRIPTION

Various exemplary embodiments of the present disclosure will now be described in detail with reference to the accompanying drawings. The description of the exemplary embodiments is merely illustrative and is in no way intended as a limitation to the present disclosure, its application or use. The present disclosure may be implemented in many different forms, which are not limited to the embodiments described herein. These embodiments are provided to make the present disclosure thorough and complete, and fully convey the scope of the present disclosure to those skilled in the art. It should be noticed that: relative arrangement of components and steps, material composition, numerical expressions, and numerical values set forth in these embodiments, unless specifically stated otherwise, should be explained as merely illustrative, and not as a limitation.

The use of the terms “first”, “second” and similar words in the present disclosure do not denote any order, quantity or importance, but are merely used to distinguish between different parts. A word such as “comprise”, “include” or variants thereof means that the element before the word covers the element(s) listed after the word without excluding the possibility of also covering other elements. The terms “up”, “down”, “left”, “right”, or the like are used only to represent a relative positional relationship, and the relative positional relationship may also be changed correspondingly if the absolute position of the described object changes.

In the present disclosure, when it is described that a particular device is located between the first device and the second device, there may be an intermediate device between the particular device and the first device or the second device, and alternatively, there may be no intermediate device. When it is described that a particular device is connected to other devices, the particular device may be directly connected to said other devices without an intermediate device, and alternatively, may not be directly connected to said other devices but with an intermediate device.

All the terms (including technical and scientific terms) used in the present disclosure have the same meanings as understood by those skilled in the art of the present disclosure unless otherwise defined. It should also be understood that terms as defined in general dictionaries, unless explicitly defined herein, should be interpreted as having meanings that are consistent with their meanings in the context of the relevant art, and not to be interpreted in an idealized or extremely formalized sense.

Techniques, methods, and apparatus known to those of ordinary skill in the relevant art may not be discussed in detail, but where appropriate, these techniques, methods, and apparatuses should be considered as part of this specification.

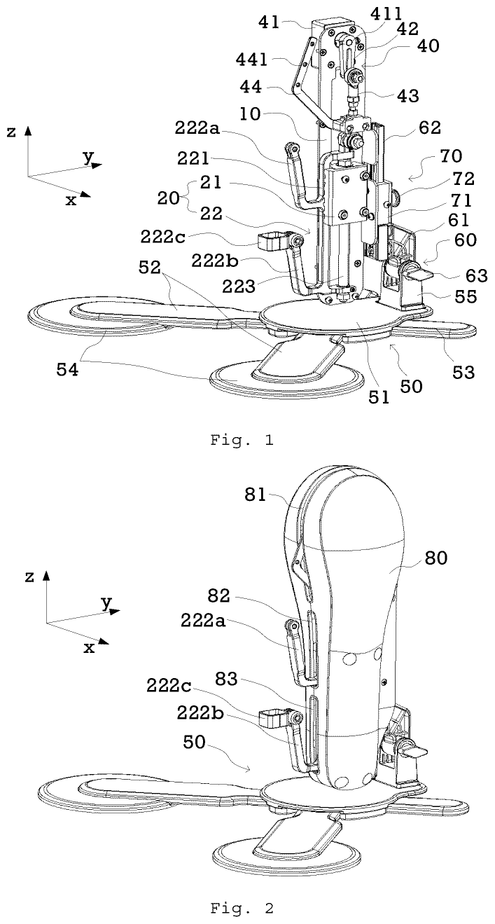

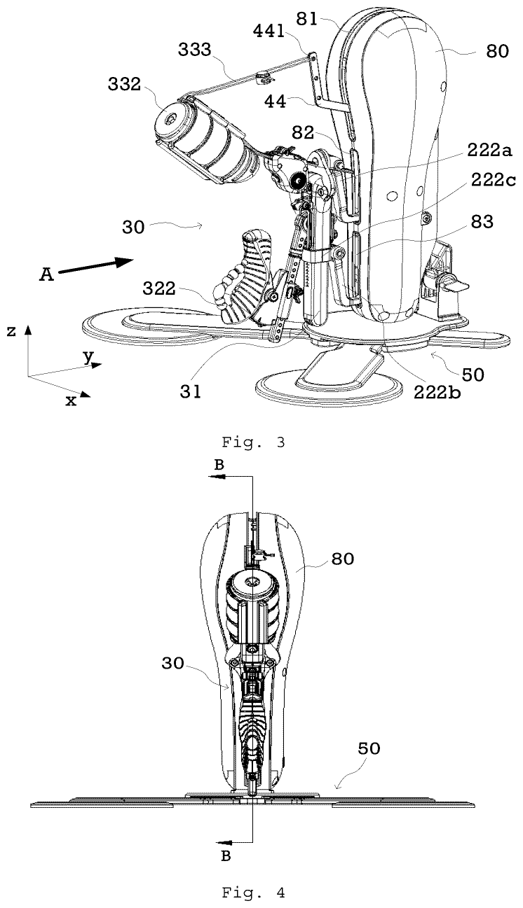

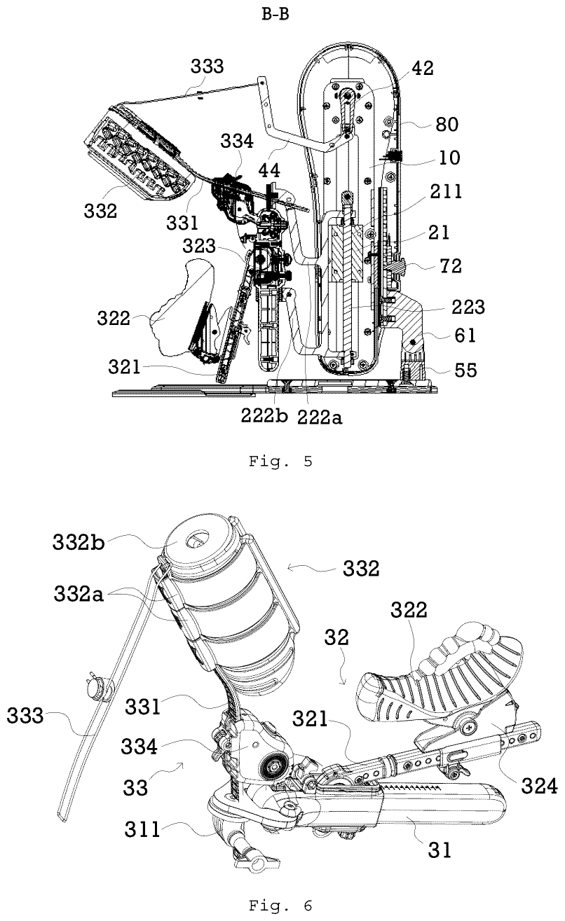

FIG. 1 is a schematic structural view of a health care massage device according to some embodiments of the present disclosure, in which the massager assembly and the protective shell are removed. FIG. 2 is a schematic structural view of a health care massage device according to some embodiments of the present disclosure, in which the massager assembly is removed and the protective shell is retained. FIG. 3 is a schematic view of a mounting structure with a protective shell in a health care massage device according to some embodiments of the present disclosure. FIG. 4 is a schematic structural view of FIG. 3 viewed in the direction A. FIG. 5 is a schematic structural view of the BB section in FIG. 4.

Referring to FIGS. 1 to 5, in some embodiments, the present disclosure provides a health care massage device, which comprises: a main support 10, a reciprocating mechanism 20, a massager assembly 30 and a swing mechanism 40. The main support 10 is capable of supporting the reciprocating mechanism 20, the massager assembly 30 and the swing mechanism 40, and may be made of a material with certain rigidity and strength, for example, a metal such as aluminum and iron or an alloy such as stainless steel. In FIGS. 1 and 5, the main support 10 may use a sheet structure to reduce the occupied space. The main support 10 may also be provided with some hollowed-out portions for reducing weight, or some reinforcing portions for enhancing the structural stability.

The reciprocating mechanism 20 includes a fixed portion 21 and a moving portion 22. The fixed portion 21 is fixedly connected to the main support 10, for example, by welding, adhesion and threaded connection. The moving portion 22 reciprocates linearly relative to the fixed portion 21 along a first direction and a direction opposite to the first direction. The first direction here may be set according to the shape and size of the main support 10.

Referring to FIGS. 1 to 3, if the length direction of the main support is parallel to the z-axis direction, the first direction may be set as the z-axis direction. Accordingly, the moving portion 22 is capable of reciprocating linearly relative to the fixed portion 21 along the z-axis direction and a direction opposite to the z-axis direction. The x-axis direction and the y-axis direction are both perpendicular to the z-axis direction. The user may lie down along the y-axis direction or a direction opposite to the y-axis direction, and the lying direction of the user may also form a certain included angle with the y-axis.

The massager assembly 30 has a carrying support 31, an anus massage member 32 and a penis massage member 33 which are both mounted on the carrying support 31. The anus massage member 32 can provide squeezing and gliding massage to the anus of the user and the skin around the anus, and the penis massage member 33 can provided squeezing and gliding massage to the penis of the user. Since the anus massage member 32 and the penis massage member 33 are mounted on the carrying support 31, the movement of the anus massage member 32 and the penis massage member 33 may be realized by driving the movement of the carrying support 31.

The carrying support 31 is mounted on the moving portion 22 and moves along with the movement of the moving portion 22 so as to drive the anus massage member 32 and the penis massage member 33 to reciprocate. The swing mechanism 40 is capable of swinging relative to the main support 10, and the swing mechanism 40 is connected with the penis massage member 33, and the penis massage member 33 is configured to swing relative to the carrying support 31 under the driving of the swing mechanism 40.

For the user, the penis may swing to a certain extent relative to the trunk of human body. According to the present embodiment, the main support is provided with a reciprocating mechanism and a swing mechanism to drive the massager assembly, so that the anus massage member and the penis massage member in the massager assembly may simultaneously realize the sliding massage effect on the anus and penis of the user. Moreover, the sliding friction massage of the penis in a swinging state is also added, so that on the one hand, the massage stimulation effect is enhanced; on the other hand, there is no need for the user to manually drive the massager assembly or depend on the initiative movements of human body. Therefore, the user is less prone to fatigue and more comfortable during a long massage.

Referring to FIGS. 1 and 5, in some embodiments, the swing mechanism 40 is hinged with the moving portion 22 so as to drive the moving portion 22 to reciprocate relative to the fixed portion 21 by the swing of the swing mechanism 40. This structure may reduce the power units in the health care massage device, thereby reducing the cost and lessening the energy consumption. Moreover, this structure may also realize the linkage between the swing mechanism and the reciprocating mechanism, so as to obtain the synchronous massage effect of the anus and the penis. In other embodiments, the swing mechanism 40 may also be independent of the movement of the moving portion 22 of the reciprocating mechanism 20, and driven by different power units respectively, so that it is possible to realize more flexible control functions and meet different massage needs of the user.

Referring to FIGS. 1 to 3 and 5, in some embodiments, the swing mechanism 40 includes: a torque output element 41, a crank 42 and a rocker arm 43. The torque output element 41 is fixedly connected to the main support 10 and provided with a power output shaft 411 configured to output a torque. One end of the crank 42 is fixedly connected to the power output shaft 411 so as to rotate around the axis of the power output shaft 411 under the driving of the power output shaft 411.

Specifically, the torque output element 4 may include: a power adapter, an electric motor and a transmission. The electric motor is electrically connected with the power adapter and connected with the input end of the transmission, and the output end of the transmission is fixedly connected to the crank 42 as the power output shaft 411, and the output voltage of the power adapter is adjustable. The user may connect the power adapter to the power supply, so that the electric motor obtains electric energy. Different output speeds of the electric motor may be obtained by adjusting an output voltage of the power adapter, and the output speed of the electric motor is output to the crank 42 by the power output shaft at a suitable speed and torque through the transmission.

One end of the rocker arm 43 is hinged with the moving portion 22, and the other end is hinged with the end of the crank 42 away from the power output shaft 411, so as to swing under the driving of the crank 42 and drive the moving portion 22 to reciprocate relative to the fixed portion 21. The connecting rod 44 is fixedly connected to the rocker arm 43 and connected with the penis massage member 33, so as to drive the penis massage member 33 to swing relative to the carrying support 31 along with the swing of the rocker arm 43. The rocker arm 43 serves both the power transmission from the swing mechanism 40 to the moving portion 22 and the swing driving effect on the connecting rod 44, thereby realizing the simultaneous driving effect of the anus massage member 32 and the penis massage member 33.

Considering the movement stability of the moving portion 22 in the reciprocating mechanism 20 relative to the fixed portion 21, referring to FIGS. 1 to 5, in some embodiments, the fixed portion 21 includes a guide hole 211. The moving portion 22 includes: a moving member 221 and a sliding shaft 223. The moving member 221 has at least one support arm connected to the carrying support 31. The sliding shaft 223 is fixedly connected with or integrally formed with the moving member 221. The sliding shaft 223 passes through the guide hole 211 and is slidably mated with the guide hole 211 in the first direction. In this way, the sliding shaft 223 is mated with the guide hole 211, so that the movement of the moving portion 22 may be more reliable and stable, thereby avoiding the swaying during reciprocating to affect the massage effect.

The support arm in the moving member 221 can extend outwards towards a direction away from the main support 10 to avoid that the massager assembly connected with the support arm approaches the main support 10 so much as to cause movement interference. In order to allow a reliable connection between the support arm and the carrying support 31, in FIGS. 1 to 3 and 5, the at least one support arm may include: a first support arm 222a and a second support arm 222b. The free end of the first support arm 222a is hinged with the end of the carrying support 31. The free end of the second support arm 222b is provided with a support sleeve 222c rotatable relative to the second support arm 222b. The support sleeve 222c is configured to be sheathed on the carrying support 31.

The massager assembly 30 may be removed from the first support arm 222a and the second support arm 222b for replacement as required. Accordingly, the first support arm 222a and the second support arm 222b may be connected with various massager assemblies having a penis massage member and an anus massage member, or other forms of massager assemblies. The outer contour of the carrying support 31 is wrapped and fixed by the support sleeve 222c, and the connection structure 311 at the end of the carrying support 31 is connected and fixed by the first support arm 222a, so that the connection between the support arm and the carrying support 31 may be more reliable. Moreover, the fixing method of the support sleeve 222c may simplify the connection structure on the carrying support 31, so as to reduce the weight and space occupation of the massager assembly.

Upon installation, the user may first insert the carrying support 31 into the support sleeve 222c, and then adjust the connection structure at the end of the carrying support 31 so that the connection structure is aligned with the free end of the first support arm 222a, and then both of them are connected and fixed.

FIG. 6 is a schematic structural view of a massager assembly in a health care massage device according to some embodiments of the present disclosure. Referring to FIGS. 3 to 6, in some embodiments, the penis massage member 33 includes: a penis massage arm 331 and a penis massage head 332. The penis massage arm 331 is swingably arranged on the carrying support 31. The penis massage head 332 is arranged on the penis massage arm 331 and configured to massage the penis. The connecting rod 44 is connected with the penis massage arm 331 or the penis massage head 332 through a flexible string 333 or a rigid rod, so as to drive the penis massage head 332 and the penis massage arm 331 to swing through a traction of the flexible string 333 or the rigid rod.

When the penis massage arm 331 is subjected to a traction itself, it is possible to realize the swing to a certain extent on the carrying support, so as to drive the penis massage head 332 to swing. Moreover, in order to realize the swing of the penis massage head 332 to a greater extent, it is possible to allow that the material of the penis massage arm 331 is an elastic material, for example, a metallic elastic material such as spring steel or a non-metallic elastic material such as hard plastic.

In this way, by swinging the connecting rod 44, the penis massage head 332 and the penis massage arm 331 may be trailed to different positions through the flexible string 333 or the rigid rod, thereby realizing the swinging of the penis massage head 332 and the penis massage arm 331. Moreover, the swinging of the penis massage head 332 enables the penis in contact with the penis massage head 332 to realize the massage effect of sliding friction while swinging, thereby enhancing the comfort in use.

In FIGS. 1 and 5, the connecting rod 44 may include a folded rod, a linear rod or an arc-shaped rod, or a rod in a shape combining a linear segment and an arc segment. The shape and size of the connecting rod 44 may be designed according to a layout relationship of components in the health care massage device.

The connecting rod 44 may be provided with a plurality of connecting holes. The flexible string 333 or the rigid rod may be selectively connected to any one of the connecting holes. By connecting different connecting holes, it is possible to change a force arm for trailing the penis massage head 332 or the penis massage arm 331, so as to change a swing amplitude of the penis massage head 332 and the penis massage arm 331, and meet different physical conditions or comfort requirements of the user.

In some embodiments, the length of the flexible string 333 or the rigid rod is adjustable. In FIG. 3, the flexible string 333 is arranged between the penis massage head 332 and the connecting rod 44, and the flexible string 333 may be provided with an adjusting buckle for adjusting a length, so that the initial angle of the penis massage head 332 may be better matched with the penis erection angle of the user according to different physical conditions or comfort requirements of the user, thereby enhancing the comfort in use. In addition, referring to FIG. 5, the penis massage arm 331 may also adjust a length of the penis massage arm 331 facing towards human body relative to the carrying support 31 through the length adjustment mechanism 334, so that the initial position of the penis massage head 332 may be better matched with the penis of the user, thereby enhancing the comfort in use.

Referring to FIGS. 3, 5 and 6, in some embodiments, the penis massage head 332 includes: a C-shaped mounting frame 332a and a soft rubber sleeve 332b. The C-shaped mounting frame 332a is arranged on the penis massage arm 331 in an adjustable position. The soft rubber sleeve 332b has a massage cavity for accommodating the penis, and the cavity wall of the massage cavity may be provided with granular or striped protrusions. The soft rubber sleeve 332b is detachably provided in the C-shaped mounting frame 332a. The user may selectively replace massage cavities with different shapes or soft rubber sleeves 332b with different lengths, so as to adapt to the penis size of different users and obtain different massage effects.

Referring to FIGS. 5 and 6, in some embodiments, the anus massage member 32 includes: an anus massage arm 321, an anus massage head 322 and a torsion spring 323. One end of the anus massage arm 321 is hinged to the carrying support 31. The carrying support 31 is provided with an inwardly concave portion for accommodating an end of the anus massage arm 321, so that the concave portion allows the anus massage arm 321 to swing relative to the carrying support 31 within a certain angle range. The anus massage head 322 is arranged on the anus massage arm 321, and may but is not limited to be fixed at the end of the anus massage arm 321.

The fixed position of the anus massage head 322 on the anus massage arm 321 may be adjusted as required. For example, the anus massage member 32 may further include a sliding sleeve 324 which is connected with the anus massage head 322 and slidably sleeved on the anus massage arm 321, so that the anus massage head 322 may be adjusted in position in the length direction of the anus massage arm 321.

The anus massage head 322 may be provided with striped or granular protrusions for realizing a squeezing and scraping massage effect on the anus of the user and the skin around the anus during massage. The anus massage head 322 may also be provided to be longer, so as to also perform a sliding massage on the perineum while massaging the anus.

The anus massage head 322 may be hinged with the sliding sleeve 324 so as to swing relative to the sliding sleeve 324. The sliding sleeve 324 may be provided with operation keys for locking or unlocking the relative positions of the anus massage head 322 and the sliding sleeve 324. In a locked state, the anus massage head 322 may mainly realize a massage effect of pressing and sliding friction on the anus and the skin around the anus, while in an unlocked state, the anus massage head 322 may mainly realize a massage effect of sliding friction and swinging kneading, so that the anus massage head 322 may realize different massage effects in the locked state and the unlocked state respectively.

The torsion spring 323 is connected between the anus massage arm 321 and the carrying support 31, and configured to apply an elastic force to the anus massage arm 321 to cause the anus massage head 322 to go away from the carrying support 31. In this way, the torsion spring 323 may allow the anus massage head 322 to maintain an abutting effect on the anus and the skin around the anus so as to avoid disengagement of the anus massage head 322 during a massaging process, and it is also possible to implement adjusting the squeezing massage effect by adjusting an elastic force of the torsion spring 323.

Referring to FIGS. 1 and 2, in the above-described embodiments, the anus massage head 322, the anus massage arm 321, the penis massage arm 331 and the penis massage head 332 may be installed and removed independently to satisfy the collection and cleaning requirements.

Referring to FIGS. 1 and 5, in some embodiments, the health care massage device further includes: a base structure 50, an angle adjustment mechanism 60 and a height adjustment mechanism 70. The base structure 50 may be placed in a desirable space to perform massage on the user, for example, on the bed or the floor. The angle adjustment mechanism 60 is arranged between the base structure 50 and the main support 10, and configured to adjust the pitch angle of the main support 10 relative to the base structure 50. The height adjustment mechanism 70 is arranged between the base structure 50 and the main support 10, and configured to adjust the height of the main support 10 relative to the base structure 50.

When the base structure 50 is placed on the bed, the user's the buttocks press downwards against the upper side of the base structure 50, and straddles both sides of the main support 10 with the legs. At this time, the height adjustment mechanism 70 may adjust the height of the main support 10 relative to the base structure 50, so as to adapt the position of the massager assembly 30 to the somatotype of the user. For example, for a fatter user, the main support 10 may be adjusted to be higher, while for a thinner user, the main support 10 may be adjusted to be lower.

The user may also adjust the main support 10 to a proper pitch angle by the angle adjustment mechanism 60, so that the penis massage head 332 and the anus massage head 322 in the massager assembly 30 may be in contact with the penis and anus of the user at a more comfortable angle.

In FIGS. 1 and 5, the angle adjustment mechanism 60 may include: an L-shaped bent arm 61, a linear slide rail 62 and a first locking member 63. One end of the L-shaped bent arm 61 is hinged with the base structure 50. The linear slide rail 62 is fixedly connected to the other end of the L-shaped bent arm 61. The L-shaped bent arm 61 can cause the main support 10 to lean forward relative to the hinge axis (the axis is parallel to the x-axis) along a direction opposite to the y-axis direction, so that the main support 10 may obtain a greater mounting space for mounting various mechanisms. The first locking member 63 is arranged between the L-shaped bent arm 61 and the base structure 50, and configured to lock or unlock the relative angle between the L-shaped bent arm 61 and the base structure 50. The first locking member 63 may be a threaded rod, which may have a handle conveniently operated by the fingers of a user.

The height adjustment mechanism 70 may include: a slide block 71 and a second locking member 72. The slide block 71 is sleeved on the linear slide rail 62, and slidably cooperates with the linear slide rail 62 in the first direction. The slide block 71 may have a sliding cavity, so that the inner surface of the sliding cavity is in sliding fit with the outer surface of the linear slide rail 62. The main support 10 is fixedly connected to the slide block 71, and located on one side of the slide block 71 away from the L-shaped bent arm 61. The second locking member 72 is arranged between the slide block 71 and the linear slide rail 62, and configured to lock or unlock the relative position between the slide block 71 and the linear slide rail 62. The second locking member 72 may be a threaded rod or a spring pin, which may have a handle conveniently operated by the fingers of a user.

Considering that the compound motion of the massager assembly may lead to the continuous change of the overall center of gravity, in order to cause the operation process of the health care massage device more stable and avoid rollover, referring to FIG. 1, in some embodiments, the base structure 50 includes: a bottom plate 51 and a plurality of support legs. The bottom plate is configured to mount and fix the main support 10. The plurality of support legs are hinged with the bottom plate 51, have an adjustable deployment angle relative to the bottom plate 51, and configured to support the bottom plate 51. The supporting leg may expand the support range of the bottom plate structure and realize a more stable massage process. Moreover, the deployment angle of the support leg may also be adjusted to adapt to different support surfaces.

In FIG. 1, the plurality of support legs are configured to swing within the same swing plane. The bottom plate 51 and each support leg may be designed into a sheet shape, and both located within the swing plane, so that the overall center of gravity of the health care massage device may be lower and the operation may be more stable. The plurality of support legs may include: two first support legs 52 and two second support legs 53. The free ends of the two first support legs 52 may be provided with a stabilizing plate 54 as required,, wherein the width of the stabilizing plate 54 is greater than that of the first support legs 52. The stabilizing plate 54 may allow the first supporting leg 52 to obtain a greater support area, and even when in use on a soft operation surface (for example, a soft mattress), it is also possible to ensure the operation stability of the health care massage device. In addition, the legs of the user may press the first support leg 52 and the stabilizing plate 54, so that the health care massage device is less prone to rollover.

The two second support legs 53 are located on an opposite side of the two first support legs 52, wherein the lengths of the two second support legs 53 are both less than those of the two first support legs 52. The short second support leg 53 may reduce the space occupation while realizing a support effect.

In order to avoid various components in the health care massage device from touching human body during operation, referring to FIGS. 2 to 5, in some embodiments, the health care massage device further comprises: a protective shell 80 sleeved outside the main support 10. The reciprocating mechanism 20 and the swing mechanism 40 are both partially arranged within the protective shell 80, and the massager assembly 30 is arranged outside the protective shell 80. The protective shell 80 may prevent a user or an object around the health care massage device from interfering with a reliable operation of the reciprocating mechanism 20 and the swing mechanism 40, and avoid human body from injury, and may also improve an overall aesthetic feeling of the health care massage device.

The protective shell 80 may be formed by splicing two shell halves. The protective shell 80 may be provided with a plurality of elongated slots for the reciprocating mechanism 20 and the swing mechanism 40 to extend out of the protective shell 80. In FIGS. 2 and 3, the protective shell 80 may be provided with a first elongated slot 81 that allows the connecting rod 44 to swing, a second elongated slot 82 and a third elongated slot 83 that allow the first support arm 222a and the second support arm 222b to translate within a certain range. The first support arm 222a is located between the second support arm 222b and the connecting rod 44, and the second elongated slot 82 is located between the first elongated slot 81 and the third elongated slot 83.

In the above-described embodiments, the health care massage device may also include other accessories, for example, a buttocks support air cushion, a power supply, and the like. The health care massage device may automatically perform a massage operation when the user is in a lying position, and may also automatically perform a massage operation when the user is in a standing position.

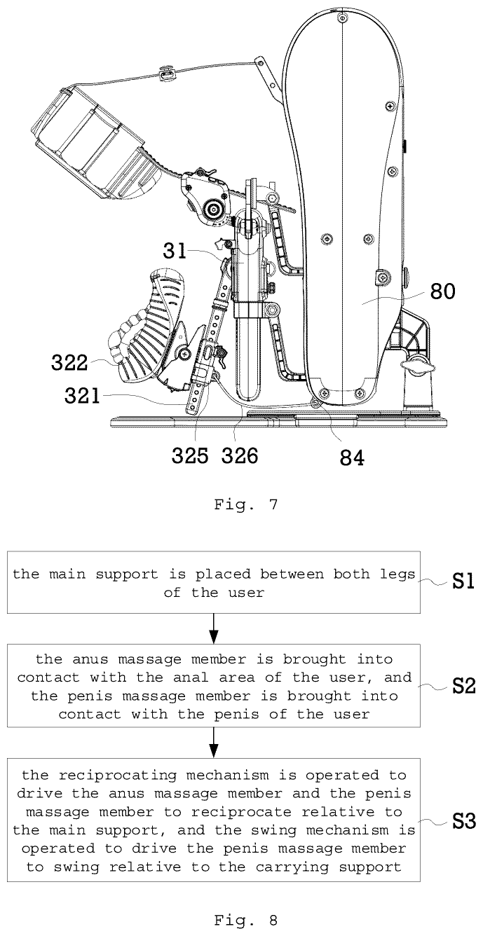

FIG. 7 is a schematic view of a mounting structure with a protective shell in a health care massage device according to other embodiments of the present disclosure. Referring to FIG. 7, in some embodiments, the health care massage device further comprises: a protective shell 80 sleeved outside the main support 10. The protective shell 80 is connected with the anus massage arm 321 or the anus massage head 322 through the flexible string 326 (or a rigid rod), so as to drive the anus massage head 322 and the anus massage arm 321 to swing relative to the carrying support 31 during the movement process of the carrying support 31 through a traction of the flexible string 326 (or a rigid rod).

In FIG. 7, the bottom of the protective shell 80 may be provided with a hook structure 84, which is connected with the hook structure 325 at the bottom of the anus massage head 322 through the flexible string 326. When the massager assembly moves upwards, under a pulling force of the flexible string 326, the anus massage head 322 goes away from the anus of human body. On the contrary, when the massager assembly moves downwards, the anus massage head 322 approaches the anus of human body under the action force of the torsion spring 323. In this way, with the vertical reciprocating movement of the massager assembly, the anus massage head 322 realizes the reciprocating movement of “going away from approaching” the anus. Thus, the massage effect of pressing and sliding friction on the anus and surrounding skin by the anus massage head 322 is realized.

FIG. 8 is a flow chart of an operation method for a health care massage device according to some embodiments of the present disclosure. Referring to FIG. 8, in some embodiments, the operation method for a health care massage device in the embodiments described previously includes: steps S1 to S3. In step S1, the main support 10 is placed between both legs of the user. In step S2, the anus massage member 32 is brought into contact with the anal area of the user, and the penis massage member 33 is brought into contact with the penis of the user. In step S3, the reciprocating mechanism 20 is operated to drive the anus massage member 32 and the penis massage member 33 to reciprocate relative to the main support 10, and the swing mechanism 40 is operated to drive the penis massage member 33 to swing relative to the carrying support 31.

In the above-described step S3, the reciprocating mechanism 20 and the swing mechanism 40 may be automatically driven by the torque output element 41, so that the massager assembly 30 may automatically perform a massage operation without manually operating of massager assembly by the user, so that it is less prone to fatigue during a long use, and it is possible to obtain a more comfortable massage effect.

In other embodiments, the operation method for a health care massage device in the embodiments described previously further includes: driving the anus massage head 322 and the anus massage arm 321 of the anus massage member 32 to swing relative to the carrying support 31 during the movement process of the carrying support 31 through a traction of the flexible string or the rigid rod. For example, when the massager assembly moves upwards, the anus massage head goes away from the anus of human body under the pulling force of the flexible string or the rigid rod. On the contrary, when the massager assembly moves downwards, the anus massage head approaches the anus of human body under the action force of the torsion spring of the anus massage arm. In this way, with the vertical reciprocating movement of the massager assembly, the anus massage head realizes the reciprocating movement of “going away from—approaching” the anus. Thus, the massage effect of pressing and sliding friction on the anus and surrounding skin by the anus massage head is realized.

Referring to various embodiments and accompanying drawings of the device and method described previously, when the user intends to massage by the health care massage device, the user may lie down, so that the buttocks are supported by the buttock inflatable air cushion so as to be lifted properly, and the bottom plate structure is compressed and fixed between the buttock inflatable air cushion and the mattress. The main support is clamped between both legs of human body and approaches the perineum, the anus massage head compresses a massage area such as the anus and the perineum, the soft rubber sleeve on the penis massage head is sleeved on the penis, and the flexible string is adjusted to a proper position and a proper length.

The power supply is turned on and the torque output element is started. When the crank rotates, the rocker arm is driven to swing, so that the rocker arm drives swinging back and forth of the connecting rod and sliding reciprocation of sliding component. The swinging of the connecting rod back and forth drives the penis massage head to generate sliding massage stimulation relative to the penis, and in conjunction with the vertical sliding stimulation, swinging back and forth of the penis is incorporated to enhance the massage stimulation effect. The sliding component drives the anus massage head to reciprocate vertically, so that the anus massage head generates sliding massage stimulation relative to the anus, the perineum and other areas.

The penis massage head and the anus massage head move synchronously, so that the massage stimulation effects of different areas may be superimposed synchronously, thereby enhancing the massage stimulation effect. Different combinations of the soft rubber sleeve and the anus massage head may produce different massage effects. The output voltage of the power supply is adjusted so that it is possible to adjust the rotation speed of the electric motor, and further adjust the reciprocating speed of the massager assembly, so as to obtain different massage effects.

The health care massage device may also be used when human body is a standing position. When the user is in a standing position, the main support may be laid flat and clamped between the legs. When the electric motor operates, the massager assembly moves back and forth, so as to generate massage stimulation that combines both sliding and swing relative to the penis, the anus, the perineum and other massage areas.

Hereto, various embodiments of the present disclosure have been described in detail. Some details well known in the art are not described in order to avoid obscuring the concept of the present disclosure. According to the above description, those skilled in the art would fully understand how to implement the technical solutions disclosed here.

Although some specific embodiments 0 the present disclosure have been described in detail by way of examples, those skilled in the art should understand that the above examples are only for an illustrative purpose, rather than limiting the scope of the present disclosure. It should be understood by those skilled in the art that modifications to the above-described embodiments and equivalent replacements to some technical features may be made without departing from the scope and spirit of the present disclosure. The scope of the present disclosure is defined by the appended claims.

1. A health care massage device, comprising:
a main support (10);
a reciprocating mechanism (20) comprising a fixed portion (21) fixedly connected to the main support (10) and a moving portion (22) reciprocating linearly along a first direction and a direction opposite to the first direction relative to the fixed portion (21);
a massager assembly (30) having a carrying support (31), and an anus massage member (32) and a penis massage member (33) which are both mounted on the carrying support (31); and
a swing mechanism (40) connected with the penis massage member (33) and capable of swinging relative to the main support (10),
wherein the carrying support (31) is mounted on the moving portion (22) and moves along with a movement of the moving portion (22) so as to drive the anus massage member (32) and the penis massage member (33) to reciprocate, and the penis massage member (33) is configured to swing relative to the carrying support (31) under driving of the swing mechanism (40).

2. The health care massage device according to claim 1, wherein the swing mechanism (40) is hinged with the moving portion (22) so as to drive the moving portion (22) to reciprocate relative to the fixed portion (21) by a swinging of the swing mechanism (40).

3. The health care massage device according to claim 2, wherein the swing mechanism (40) comprises:
a torque output element (41) fixedly connected to the main support (10), having a power output shaft (411) and configured to output a torque;
a crank (42), one end of which is fixedly connected to the power output shaft (411) so as to rotate around an axis of the power output shaft (411) under driving of the power output shaft

(411) ;
a rocker arm (43), one end of which is hinged with the moving portion (22), and the other end of which is hinged with one end of the crank (42) away from the power output shaft (411) so as to swing under driving of the crank and drive the moving portion (22) to reciprocate relative to the fixed portion (21); and
a connecting rod (44) fixedly connected to the rocker arm (43) and connected with the penis massage member (33) so as to drive the penis massage member (33) to swing relative to the carrying support (31) along with swing of the rocker arm (43).

4. The health care massage device according to claim 3, wherein the penis massage member (33) comprises:
a penis massage arm (331) swingably arranged on the carrying support (31); and
a penis massage head (332) arranged on the penis massage arm (331) and configured to massage a penis,
wherein the connecting rod (44) is connected with the penis massage arm (331) or the penis massage head (332) through a flexible string or a rigid rod, so as to drive the penis massage head (332) and the penis massage arm (331) to swing through a traction of the flexible string or the rigid rod.

5. The health care massage device according to claim 4, wherein a material of the penis massage arm (331) is an elastic material.

6. The health care massage device according to claim 4, wherein a length of the flexible string or the rigid rod is adjustable.

7. The health care massage device according to claim 4, wherein the penis massage head (332) comprises:
a C-shaped mounting frame (332a) arranged on the penis massage arm (331) in an adjustable position; and
a soft rubber sleeve (332b) having a massage cavity for accommodating a penis,
wherein the soft rubber sleeve (332b) is detachably provided in the C-shaped mounting frame (332a).

8. The health care massage device according to claim 1, wherein the anus massage member (32) comprises:
an anus massage arm (321), one end of which is hinged on the carrying support (31);
an anus massage head (322) arranged on the anus massage arm (321); and
a torsion spring (323) connected between the anus massage arm (321) and the carrying support (31), and configured to apply an elastic force to the anus massage arm (321) to cause the anus massage head (322) to go away from the carrying support (31).

9. The health care massage device according to claim 1, wherein the fixed portion (21) comprises a guide hole (211), and the moving portion (22) comprises:
a moving member (221) having at least one support arm connected with the carrying support (31); and
a sliding shaft (223) fixedly connected to or integrally formed with the moving member (221),
wherein the sliding shaft (223) passes through the guide hole (211) and is slidably mated with the guide hole (211) in the first direction.

10. The health care massage device according to claim 9, wherein the at least one support arm comprises:
a first support arm (222a), a free end of which is connected with an end of the carrying support (31); and
a second support arm (222b), a free end of which is provided with a support sleeve (222c) rotatable relative to the second support arm (222b),
wherein the support sleeve (222c) is configured to be sheathed on the carrying support (31).

11. The health care massage device according to claim 1, further comprising:
a base structure (50);
an angle adjustment mechanism (60) arranged between the base structure (50) and the main support (10), and configured to adjust a pitch angle of the main support (10) relative to the base structure (50); and
a height adjustment mechanism (70) arranged between the base structure (50) and the main support (10), and configured to adjust a height of the main support (10) relative to the base structure (50).

12. The health care massage device according to claim 11, wherein the angle adjustment mechanism (60) comprises:
an L-shaped bent arm (61), one end of which is hinged with the base structure (50);
a linear slide rail (62) fixedly connected to the other end of the L-shaped bent arm (61); and
a first locking member (63) arranged between the L-shaped bent arm (61) and the base structure (50), and configured to lock or unlock a relative angle between the L-shaped bent arm (61) and the base structure (50).

13. The health care massage device according to claim 12, wherein the height adjustment mechanism (70) comprises:
a slide block (71) sleeved on the linear slide rail (62) and slidably mated with the linear slide rail (62) in the first direction; and
a second locking member (72) arranged between the slide block (71) and the linear slide rail (62) and configured to lock or unlock a relative position between the slide block (71) and the linear slide rail (62),
wherein the main support (10) is fixedly connected to the slide block (71).

14. The health care massage device according to claim 11, wherein the base structure (50) comprises:
a bottom plate (51); and
a plurality of support legs hinged with the bottom plate (51), having an adjustable deployment angle relative to the bottom plate (51), and configured to support the bottom plate (51).

15. The health care massage device according to claim 14, wherein the plurality of support legs are configured to swing within the same swing plane, and the plurality of support legs comprise:
two first support legs (52), free ends of which are both provided with a stabilizing plate (54), wherein a width of the stabilizing plate (54) is greater than that of the first support legs (52); and
two second support legs (53) located on an opposite side of the two first support legs (52), wherein lengths of the two second support legs (53) are both less than those of the two first support legs (52).

16. The health care massage device according to claim 1, further comprising:
a protective shell (80) sleeved outside the main support (10),
wherein the reciprocating mechanism (20) and the swing mechanism (40) are both partially arranged inside the protective shell (80), and the massager assembly (30) is arranged outside the protective shell (80).

17. The health care massage device according to claim 3, wherein the torque output element (41) comprises: a power adapter, an electric motor and a transmission, wherein the electric motor is electrically connected with the power adapter and connected with an input end of the transmission, an output end of the transmission is fixedly connected to the crank (42) as the power output shaft (411), and the output voltage of the power adapter is adjustable.

18. The health care massage device according to claim 17, further comprising:
a protective shell (80) sleeved outside the main support (10),
wherein the protective shell (80) is connected with the anus massage arm (321) or the anus massage head (322) through a flexible string or a rigid rod, so as to drive the anus massage head (322) and the anus massage arm (321) to swing relative to the carrying support (31) during a movement process of the carrying support (31) under a traction of the flexible string or the rigid rod.

19. An operation method for a health care massage device according to claim 1, comprising:
placing the main support (10) between both legs of a user;
causing the anus massage member (32) in contact with an anal area of the user and causing the penis massage member (33) in contact with a penis of the user; and
operating the reciprocating mechanism (20) to drive the anus massage member (32) and penis massage member (33) to reciprocate relative to the main support (10), and operating the swing mechanism (40) to drive the penis massage member (33) to swing relative to the carrying support (31).

20. The operation method according to claim 19, further comprising:
driving the anus massage head (322) and the anus massage arm (321) of the anus massage member (32) to swing relative to the carrying support (31) during a movement process of the carrying support (31) under a traction of a flexible string or a rigid rod.
